(19) United States
(12) Patent Application Publication
(10) Pub. No.: US 2020/0090061 A1
(43) Pub. Date: Mar. 19, 2020

(54) MACHINE ASSISTED TROUBLESHOOTING OF A CUSTOMER SUPPORT ISSUE

(71) Applicant: Conduent Business Services, LLC, Dallas, TX (US)

(72) Inventors: Edward Charles Southey, Sherborne (GB); Timothy John Forsyth, Southampton (GB); Mark Piper, Christchurch (GB); David John Butt, Shaftesbury (GB); Paul Martin Wallingford, Southampton (GB); Daniel James Griffin, Bournemouth (GB); Jeremy J. McKinley, Dorchester (GB); Benjamin James Hooper, Poole (GB); Michael Carl Thelin, Gävle (SE); Nicholas Mark Gyles, Christchurch (GB); Timothy T. Joyce, Poole (GB)

(73) Assignee: Conduent Business Services, LLC, Dallas, TX (US)

(21) Appl. No.: 16/690,800

(22) Filed: Nov. 21, 2019

Related U.S. Application Data
(63) Continuation of application No. 13/795,087, filed on Mar. 12, 2013, now abandoned.

(51) Int. Cl. G06N 5/04

(52) U.S. Cl. CPC G06N 5/04

(57) ABSTRACT

A knowledge interface is provided that interacts with a user to identify a solution to a customer problem or issue with respect to a particular product or service. The knowledge interface includes data processing functionality configured to dynamically generate a number of components that are presented in at least one display window for display to the user. The components include first data identifying a set of predetermined symptoms linked to the problem or issue and related interface elements for classification of the set of predetermined symptoms, second data identifying a set of predetermined root causes linked to the set of predetermined symptoms and related interface elements for classification of the set of predetermined root causes, and third data identifying a set of solutions linked to the set of predetermined root causes. The third data identifies a best solution based upon the predetermined root causes and their associated class designations.

### BACKGROUND

### 1. Field

The present application relates to systems and methods employing machines (expert systems) to aid in troubleshooting customer support issues.

### 2. Related Art

Knowledge systems have been created to solve specific problems, and provided through customer care tools to agents and end customers via web sites, mobile applications, printed material, etc.

It is a challenge to identify the knowledge that will provide a solution when only the symptoms are known. Often a search mechanism is available to find knowledge, but this doesn't assist with the diagnosis from the symptom, and often requires the user to have an understanding of the root cause of the problem being solved before the solution can be presented.

Other knowledge system and methods employ a question and answer model, allowing the customer to search for the question, rather than the answer. Some have a usage-based learning component that will optimize the search index for future searches.

Other systems and methods have included ‘case-based reasoning’ flows—which consist of a series of steps and decisions to identify the problem and offer the solution. These require the user to identify from a pre-defined list of symptoms, rather an accurately describing their exact symptoms. These are also constrained by scope and size, so often will not cover all the domains where a fault could occur—either within the product, the network or a third party application or service. They also have to be authored up-front, and are not generated and learnt automatically.

### SUMMARY

A knowledge interface is provided that interacts with a user-operated data processing system via networked communication to identify a solution to problem or issue experienced by a customer with respect to a particular product or service. The knowledge interface includes data processing functionality that supplies information to the user-operated data processing system. The information represents a number of components that are presented in at least one display window displayed by the user-operated data processing system. The components include:

i) first data identifying a set of predetermined symptoms linked to the problem or issue experienced by the customer;

ii) first interface elements that are configured to allow the user to classify the set of predetermined symptoms of i) into two classes including a first class of symptoms representing symptoms most likely experienced by the customer and a second class of symptoms representing symptoms most likely not experienced by the customer;

iii) second data identifying a set of predetermined root causes linked to the set of predetermined symptoms of i);

iv) second interface elements that are configured to allow the user to classify the set of predetermined root causes of iii) into two classes including a first class of root causes representing root causes most likely experienced by the customer and a second class of root causes representing root causes most likely not experienced by the customer; and

v) third data identifying a set of solutions linked to the set of predetermined root causes of iii), wherein the third data identifies a best solution based upon the predetermined root causes of iii) and their associated class designations as dictated by user input with the second interface elements.

The knowledge interface can further include a user input mechanism that is configured to enable the user to specify a natural text description of at least one symptom of the problem or issue experienced by the customer with respect to a particular product or service as well as an interface to an analysis engine that is configured to identify the set of predetermined symptoms. The analysis engine can employ statistical analysis to link the natural text description specified by user operation of the user input mechanism to the set of predetermined symptoms. In one embodiment, such statistical analysis implements a naive Bayes classification methodology. The statistical analysis can associates a confidence level with the link between the natural language textual description of the problem or issue and a given predetermined symptom. The confidence levels associated with the set of predetermined symptoms can be used by the knowledge interface to arrange the display order of the set of predetermined symptoms in the at least one display window.

Context that identifies the particular product or service can be supplied to the knowledge interface and/or can be otherwise known or derived. In one embodiment, such context is derived from interaction between a call center representative and the customer. In another embodiment, such context is supplied by input from the customer.

The components that are presented in at least one display window displayed by the user-operated data processing system can further include a user input mechanism to select a best solution and trigger the display of additional information regarding the best solution to the user (such as a document or other web content, an external link, an OTA flow for mobile device configuration and programming, device attributes, and a simulation that guides the call center representative through steps to fix a particular problem or issue). The components can further include a user input mechanism to indicate whether or not the best solution was successful in solving the problem or issue.

The knowledge interface can further include a database that stores collected data derived from interaction with the user and associated with the problem or issue. The collected data can be used to train the analysis engine for subsequent operations.

In one embodiment, the user of the knowledge interface is a call center representative.

In another embodiment, the user of the knowledge interface is the customer.

The knowledge interface can be configured such that first data, the second data and the third data are displayed in a plurality of distinct regions of a display window, wherein the plurality of regions are laid out adjacent one another across the horizontal extent of the display window. The plurality of regions can include a region that displays the first data and/or the second data after being classified in accordance with user input.

The present application also describes a method for identifying a solution to problem or issue experienced by a customer with respect to a particular product or service. The method includes supplying information to a user-operated data processing system via networked communication, the information representing a number of components that are presented in at least one display window displayed by the user-operated data processing system. The components include:

i) first data identifying a set of predetermined symptoms linked to the problem or issue experienced by the customer;

ii) first interface elements that are configured to allow the user to classify the set of predetermined symptoms of i) into two classes including a first class of symptoms representing symptoms most likely experienced by the customer and a second class of symptoms representing symptoms most likely not experienced by the customer;

iii) second data identifying a set of predetermined root causes linked to the set of predetermined symptoms of i);

iv) second interface elements that are configured to allow the user to classify the set of predetermined root causes of iii) into two classes including a first class of root causes representing root causes most likely experienced by the customer and a second class of root causes representing root causes most likely not experienced by the customer, and

v) third data identifying a set of solutions linked to the set of predetermined root causes of iii), wherein the third data identifies a best solution based upon the predetermined root causes of iii) and their associated class designations as dictated by user input with the second interface elements.

Additional details with respect to the method are disclosed and claimed.

In another aspect, a knowledge interface is described that interacts with a user to identify a solution to problem or issue experienced by a customer with respect to a particular product or service. The knowledge interface includes data processing functionality that presents a number of components in at least one display window displayed to the user. The components include:

i) first data identifying a set of predetermined symptoms linked to the problem or issue experienced by the customer;

ii) first interface elements that are configured to allow the user to classify the set of predetermined symptoms of i) into two classes including a first class of symptoms representing symptoms most likely experienced by the customer and a second class of symptoms representing symptoms most likely not experienced by the customer;

iii) second data identifying a set of predetermined root causes linked to the set of predetermined symptoms of i);

iv) second interface elements that are configured to allow the user to classify the set of predetermined root causes of iii) into two classes including a first class of root causes representing root causes most likely experienced by the customer and a second class of root causes representing root causes most likely not experienced by the customer; and

v) third data identifying a set of solutions linked to the set of predetermined root causes of iii), wherein the third data identifies a best solution based upon the predetermined root causes of iii) and their associated class designations as dictated by user input with the second interface elements.

Additional details with respect to the knowledge interface are disclosed and claimed.

### BRIEF DESCRIPTION OF THE DRAWINGS

FIG. 1 is a schematic diagram of an exemplary system to identify a solution to problem or issue experienced by a customer with respect to a particular product or service in accordance with the present application.

FIG. 2 is a diagram of an initial view of a display window displayed on a call center representative station of FIG. 1 in accordance with information supplied by the knowledge interface 19 of FIG. 1.

FIGS. 3 to 7 are diagrams of updated views of the display window of FIG. 2 displayed on a call center representative station of FIG. 1 in accordance with information supplied by the knowledge interface 19 of FIG. 1.

FIG. 8 is a diagram of a call log including information collected during user interaction with the knowledge interface 19 of FIG. 1, for example as depicted in the diagrams of FIGS. 3 to 7.

FIG. 9 is a schematic diagram of the operations carried out by the knowledge interface 19 and analysis engine 21 of FIG. 1 in presenting information to the respective call center representative operating a call center representative station of FIG. 1.

FIG. 10 is a schematic diagram of another exemplary system to identify a solution to problem or issue experienced by a customer with respect to a particular product or service in accordance with the present application.

### DETAILED DESCRIPTION OF THE PREFERRED EMBODIMENTS

In accordance with the present application, a system is provided for diagnosing and fixing problems or issues with a consumer product or service. The product or service can be electronic devices (such as a smart phone, personal digital assistant, tablet computer, notebook computer desktop computer, e-book reader, GPS device, mobile device, game console, set-top box, smart TV, digital video recorder, network router/gateway, automotive system), software products or services or other technical products or services. The problems or issues with such products and services are often difficult to identify and fix due to the complexity of such products or services. An additional complicating factor is the context in which it is used, which often involves connectivity to a local area network and the Internet through mechanisms that include GSM, CDMA, iDEN, WiMax, WiFi, LTE, Ethernet, Bluetooth, and a wide area network (ADSL, Cable, Fiber, etc.). The root cause of the problem or issue may lie with the product or service itself, with the network and its setup/provisioning, a technical fault elsewhere, or with a third party application or service, either running locally on the device (e.g. a smart phone application) or remotely (e.g. a cloud-based service). The requisite knowledge of all these relevant domains is often beyond the level attained by a call center representatives (sometimes referred to as customer support representative or agents) or by the end-user customer, resulting in a frustrating and time-consuming support experience, often with multiple calls for support to resolve the problem or issue.

The system of the present application can be configured to allow the symptoms of the problem or issue to be described in a natural language context, and thus avoids the need to translate the problem or issue that is being experienced to a list of pre-categorized symptoms or problems.

The system of the present application can also be configured to learn, through usage, the terminology that is used by customers and support staff to describe the symptoms of the problem or issue that is being experienced, and the subsequent mapping to a standardized list of symptoms.

The system of the present application can also be configured to learn the symptoms that are exhibited by a root cause problem or issue, so that future diagnosis of the same symptoms can be carried out in an efficient and effective manner.

The system of the present application can also be configured to learn which solutions are effective in solving the root cause of a problem or issue for certain exhibited symptoms.

The system of the present application can also be configured to deliver a wide variety of types of solutions (such as knowledge articles, interactive tutorials or automated fix processes, provisioning mechanisms or processes, including ‘off-line’ or manual processes).

The system of the present application can enable a novice end-user or new call center representatives to quickly become proficient at problem solving, by offering a step-by-step assisted diagnosis of a problem or issue.

The system of the present application can enable experienced call center representatives to quickly access the appropriate solution to a problem or issue through a natural language expression of the symptom(s) exhibited by the problem or issue, with the ability to skip step-by-step assisted diagnosis of the solution if desired.

The system of the present application can also be configured to track and record all troubleshooting steps and evidence associated with a problem or issue by users of the system. This feature can be useful for follow-up interactions with the same user (to avoid repeating the same steps) and also in performance monitoring.

The system of the present application can also be configured to track and records the magnitude/volume of problems and issues occurring for a particular product or service which can be used to inform the creation of new knowledge, update the type of product or another element (e.g. firmware update) to fix the problem, or to supply an appropriate solution in subsequent operations of the system.

The system of the present application can identify gaps in knowledge where no matching symptoms, route causes or solutions are available for an expression of a symptom.

The system of the present application can be configured to learn from users the solution to the described symptoms, and can apply this learning in other channels (e.g. self-service website or mobile application) for end-user customers to solve problems autonomously, without the need to contact a call center representative or other support function.

The system of the present application can be configured to tap into text streams where symptoms are being expressed, and to continually disambiguate to offer and refine the proposed solution. Text streams could include a chat session with customer care, a real-time voice analysis of the support call audio, a forum posting, a social network post (e.g. a Twitter message), a blog post or instant message.

The system of the present application can be configured to integrate to third party speech analytics platforms and APIs to enable a user to vocally describe a set of symptoms for input to the interface, and to have a solution proposed as a response to the voice input.

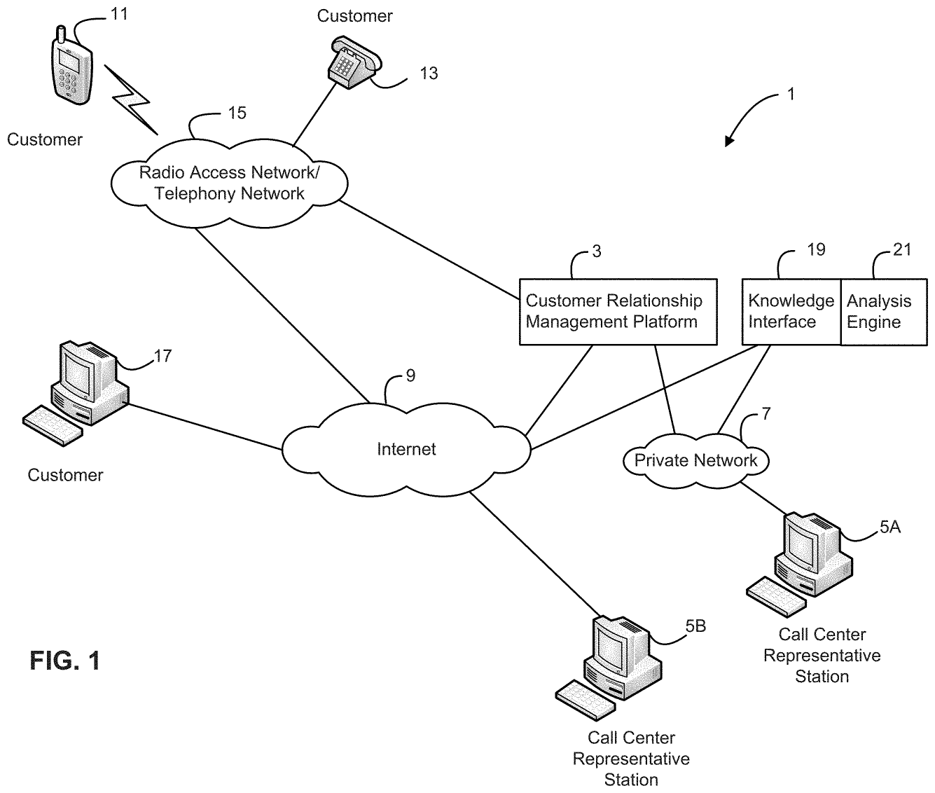

FIG. 1 illustrates an exemplary embodiment of a customer relationship system 1 in accordance with the present application. The system 1 allows customers to interact with call center representatives utilizing voice call communication (including voice over IP communication) and/or other communication methods (such as email, fax, SMS, Web collaboration or chat) to find solutions to problems or issues experienced by the respective customers. The system 1 includes a customer relationship management platform 3 that includes hardware and software functionality to service communication interaction with customers (which can involve a voice call, email, fax, SMS, Web collaboration or chat), to route the customer interactions to available call center representatives, and to store data related to the customer interactions. The customer relationship management platform 3 can be adapted to allow the call center representatives to better understand and address the problems or issues experienced by the respective customers. The customer relationship management platform 3 can be located within an enterprise's technical infrastructure or possibly realized as a hosted service that is located in one or more data centers managed by a service provider. The call center representatives interact with call center representative stations (two shown as 5A and 5B) that are connected to the customer relationship management platform 3 by a private communication network 7 or a public communication network (i.e., the Internet 9) or a combination of both as shown.

The customer service representative stations 5A, 5B are typically realized by a browser-based desktop interface served by customer relationship management platform 3 that allows a respective call center representative to log into the platform 3, to view a work queue for the call center representative as managed by the platform 3, and to provide notification that the call center representative is available to service incoming customer interactions. The browser-based interface can be adapted to allow the call center representative to manage multiple simultaneous customer service interactions (such as combinations of emails, phone calls, and Web calls). The browser-based interface can be adapted to allow the respective call center representative to accept an incoming customer interaction, release a customer interaction, or transfer a customer interaction. The browser-based interface can also be adapted to provide the respective call center representative with information about a particular customer interaction, such as how long the particular customer interaction has been assigned to the respective call center representative, and/or how long the respective call center representative has been working on the particular customer interaction, and/or customer data such as name, address, and contact information. The customer relationship management platform 3 can be realized by a wide variety of commercially-available call center platform solutions, including products from Cisco, Siebel, Amdocs, Salesforce.com, Microsoft and Oracle.

The customers can employ telephony devices (such as a mobile device 11 or a landline telephone 13) to place calls to the customer relationship management platform 3 over a radio access network/telephony network 15 for routing to a customer service representative. The customers can also employ mobile devices (such as mobile device 7) or other computer systems or communication devices (such as computer 17) to initiate other forms of communication (such as email, fax, SMS, Web collaboration, Social Media Messaging, and/or chat) to the customer relationship management platform 3 via the radio access network/telephony network 15 and/or Internet 9 for routing to a customer service representative.

The system 1 also includes a knowledge interface 19 that is operably coupled to the call center representative stations (for example the two shown as 5A, 5B) over the private network 7 or the public network 9 or a combination of both as shown. The knowledge interface 19 interacts with call center representatives via operation of the call center representative stations 5A, 5B to identify solutions to problems or issues experienced by customers in operating particular products or services. In this context, a particular product or service is identified by the customer or otherwise known. In one example, the context can be derived from interaction between the customer and a call center representative managed by the customer relationship management platform 3 where the call center representative is servicing a voice call, instant message, email or other communication from the customer who is experiencing the problem or issue in operating the product or service of interest. Such context (more specifically, data that identifies the particular device or equipment of interest) is passed by messaging or another suitable communication interface to the knowledge interface 19.

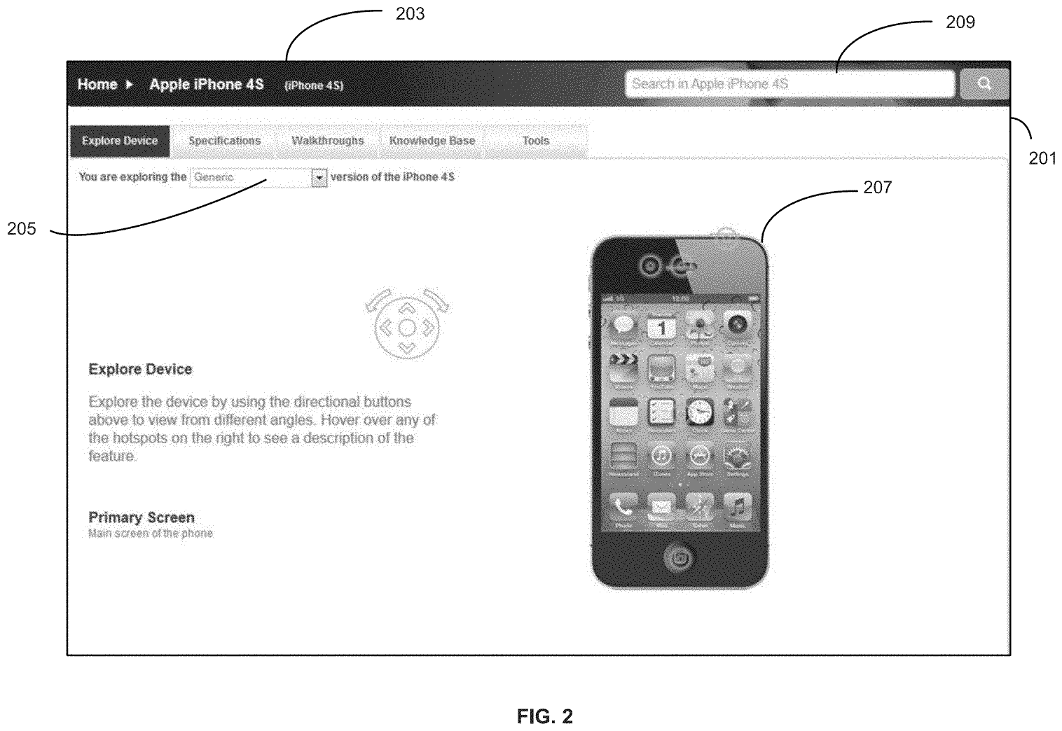

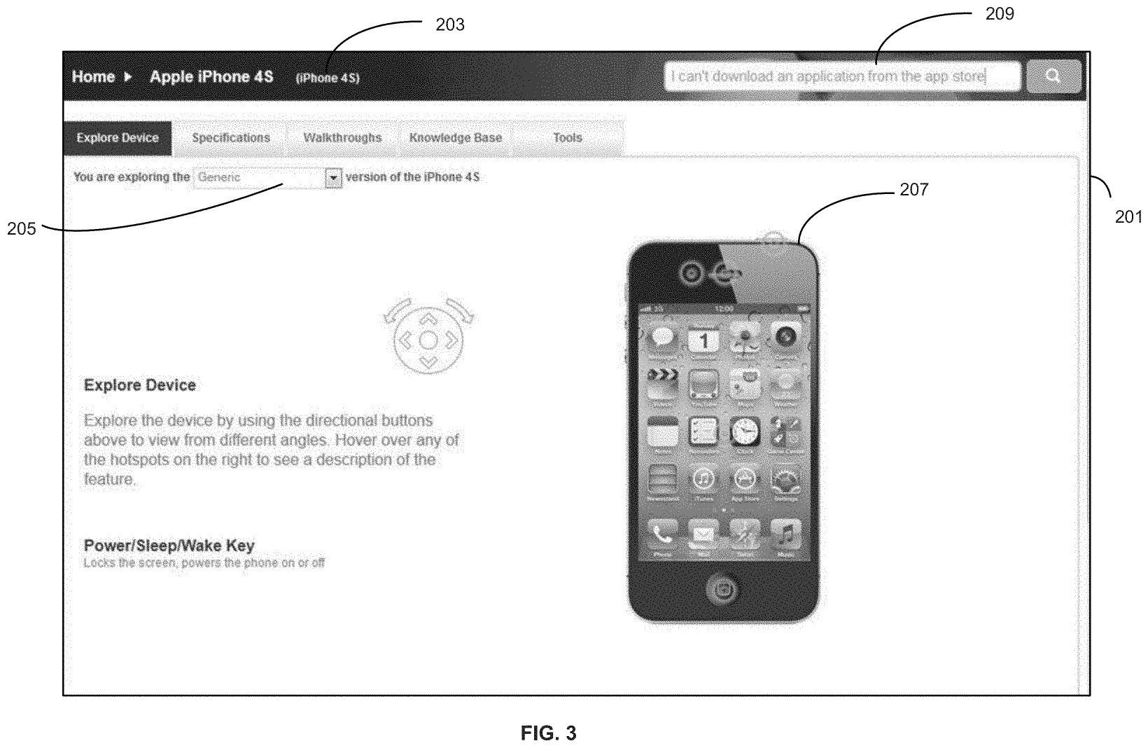

The knowledge interface 19 receives and processes the context to dynamically generate and supply information to the call center representative station 5 where the information is configured to initially present a display window (and subsequently update the display window) on the call center representative station 5. The knowledge interface 19 can be realized by application server and middleware software functionality executing on a suitable data processing platform. The data processing platform can be a single machine or distributed over multiple machines if desired. The information communicated between the knowledge interface 19 and the call center representative station 5 can include a wide variety of common web data types, such as HTML code, style sheets, scripts (such as javascripts and PHP scripts), XML documents and web pages and forms (such as ASP.net web pages and forms). The data types can include textual information, graphical information, and/or multimedia information (such as video files and/or audio files). The display window presented on the call center representative station 5 has an initial view that identifies the product or service of interest as dictated by the context. An example of the initial view of such display window 201 is shown in FIG. 2, which includes a title bar 203 that specifies the product or service of interest (in this case the IPhone 4S). Field 205 is a drop-down menu that allows the call center representative to specify the version of the product or service of interest. The initial view of the display window 201 can also include a rendering 207 of a picture of the product or service of interest. The initial view of the display window 201 further includes field 209 that allows for text input where the call center representative interacts with the knowledge interface 19 to supply a natural language textual description of a symptom for a problem or issue experienced by the customer user in operating the product or service of interest. Alternatively, real-time speech-to-text processing or other suitable user input technology can be utilized to generate the natural language textual description of the symptom based upon the input of call center representative (or the customer user). In any event, the knowledge interface 19 is configured to update field 209 of the display window 201 such that it depicts the natural language textual description of the symptom as shown in FIG. 3. In this case, the natural language textual description of the symptom is “I can't download an application from the app store.”

The system 1 also includes an analysis engine 21 operably coupled to the knowledge interface 19 by messaging or another suitable communication interface. The analysis engine 21 can also be realized by application server and middleware software functionality executing on a suitable data processing platform. The data processing platform can be a single machine or distributed over multiple machines if desired. The knowledge interface 19 is configured to pass the natural language textual description of the symptom as well as data identifying the product or service of interest to the analysis engine 21. The analysis engine 21 is configured to receive and process the natural language textual description of the symptom as well as the data identifying the product or service of interest in order to link the natural language textual description of the symptom for the product or service of interest to a set of zero or more predetermined symptoms. The analysis engine 21 can associate a confidence level with the link between the natural language textual description of the symptom for the product or service of interest and a given predetermined symptom. The linking and associated confidence levels can be based on statistical analysis.

In one embodiment, the statistical analysis of the analysis engine 21 implements a naive Bayes classification methodology that uses Bayesian theory, which provides an equation for deriving the probability of a prediction based on a set of underlying evidence. The naive Bayes classification methodology makes a simplifying assumption that the pieces of evidence are not interrelated in a particular way. This assumption is what is called the naive aspect of the algorithm (here, “naive” is a technical term, not a disparagement). The naive Bayes classification methodology employs a prediction model with parameters that are generated from a training set as is well understood in the data analysis arts. It should be understood that other suitable statistical analysis methodologies can also be used by the analysis engine 21.

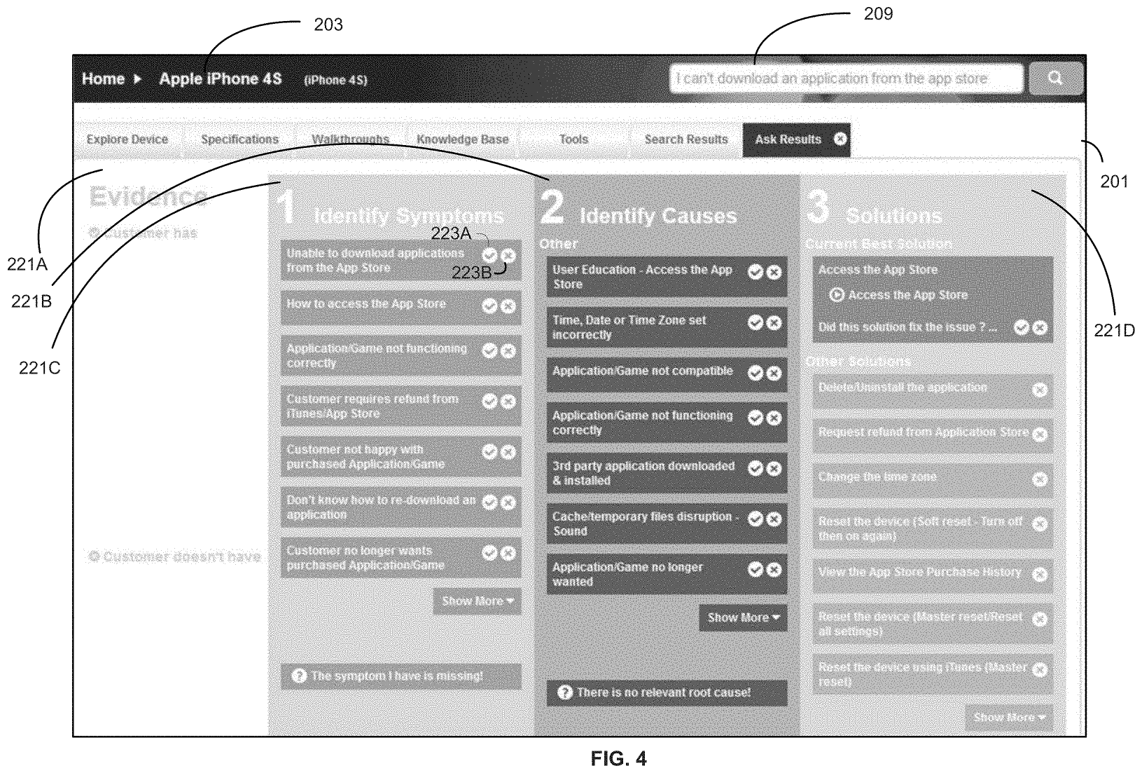

In conjunction with the operation of the analysis engine 21, the knowledge interface 19 defines four regions—Region 1 (labeled 221A), Region 2 (labeled 221B), Region 3 (labeled 221C), and Region 4 (labeled 221D)—of the display window 201 that is presented on the call center representative station 5 for display to the call center representative. These four regions 221A, 221B, 221C, 221D are preferably laid out adjacent one another across the horizontal extent of the display window 201 as shown in FIG. 4.

The knowledge interface 19 is configured such that Region 1 (labeled 221A) of the display window 201 depicts evidentiary classifications for one or more symptoms and root causes as identified by interaction of the call center representative with the information depicted in Regions 2 and 3. The evidentiary classifications include two classes: Class A and Class B. Class A includes symptom(s) and/or root cause(s) that are most likely relevant to the problem or issue experienced by the customer. Typically, the class A symptom(s) and/or root cause(s) have been experienced by the customer or are currently being experienced by the customer. Class B includes symptom(s) and/or root cause(s) that are most likely not relevant to the problem or issue experienced by the customer. Typically, the class B symptom(s) and/or root cause(s) have not been experienced by the customer or are currently not being experienced by the customer. The classification of a given symptom or root cause is dictated by interaction of the call center representative with the information depicted in Region 2 (labeled 221B) and Region 3 (labeled 221C) as described herein. The evidentiary classifications for classes A and B is initially set to null so that there is no symptoms and root causes initially depicted in Region 1 for classes A and B. When depicting more than one class A symptom in Region 1, the top-to-bottom order of the class A symptoms as displayed in Region 1 can be based on the confidence levels of the symptoms such that the more-likely class A symptoms are depicted above the less-likely class A symptoms. If the number of class A symptoms is large and cannot fully be depicted in Region 1, a slider bar or other suitable interface mechanism can be used to provide the user access to all of the class A symptoms of the set. Similarly, when depicting more than one class B symptom in Region 1, the top-to-bottom order of the class B symptoms as displayed in Region 1 can be based on the confidence levels of the symptoms such that the more-likely class B symptoms are depicted above the less-likely class B symptoms. If the number if class B symptoms is large and cannot fully be depicted in Region 1, a slider bar or other suitable interface mechanism can be used to provide the user access to all of the class B symptoms of the set.

The knowledge interface 19 is further configured such that Region 2 (labeled 221B) of the display window 201 initially depicts the set of predetermined symptoms linked to the natural language textual description of the symptom for the product or service of interest by the analysis engine 21. When depicting more than one symptom in Region 2, the top-to-bottom order of the symptoms as displayed in Region 2 can be based on the confidence levels of the symptoms such that the more-likely symptoms are depicted above the less-likely symptoms of the set. If the set of symptoms is large and cannot fully be depicted in Region 2, a slider bar or other suitable interface mechanism can be used to provide the user access to all of the symptoms of the set.

The knowledge interface 19 is further configured such that Region 3 (labeled 221C) of the display window 201 depicts a set of root causes that may exhibit the predetermined symptoms depicted in Region 2. The association between the predetermined symptoms and the root causes can be based on an acyclic directed graph constructed by expert knowledge. Initially, Region 3 depicts a set of root causes for the predetermined symptoms depicted in Region 2. When displaying more than one root cause in Region 3, the top-to-bottom order of the root causes as displayed in Region 3 can be based on the confidence levels of the associated symptoms such that the more-likely root causes are depicted above the less-likely root causes for the problem or issue experienced by the customer.

The knowledge interface 19 is further configured such that Region 4 (labeled 221D) of the display window 201 depicts a set of solutions that solves the root causes depicted in Region 3. The association between the root causes and the solutions can be based on an acyclic directed graph constructed by expert knowledge. Initially, Region 4 depicts a set of solutions associated with the root causes depicted in Region 3. When displaying more than one solution in Region 4, the top-to-bottom order of the solutions follows the ordering of the root causes displayed in Region 3 and thus more-likely solutions are depicted above the less-likely root causes for the problem or issue experienced by the customer. Note that in any point in the process, the user is able to view the set of solutions depicted in Region 4, and can select any one of the solutions to access the corresponding additional information (such as fix information specific to the solution).

Each symptom depicted in Region 2 can include one or more interface widgets (such as a tick widget 223A or cross widget 223B as shown in FIG. 4) that allows input from the call center representative to classify the associated symptom as belonging to either evidentiary class A or evidentiary class B of Region 1. The call center representative interacts with such interface widgets to classify one or more symptoms depicted in Region 2. It is also contemplated that other suitable interface schemes (such as drag and drop operations and the like) can be utilized to allow the call center representative to classify a symptom of Region 2 as belong to either evidentiary class A or evidentiary class B of Region 1. In this manner, such interaction of the call center representative can “rule-in” one or more symptoms (which thus belong to the evidentiary class A of symptoms) and/or can “rule-out” one or more symptoms (which thus belong to the evidentiary class B of symptoms).

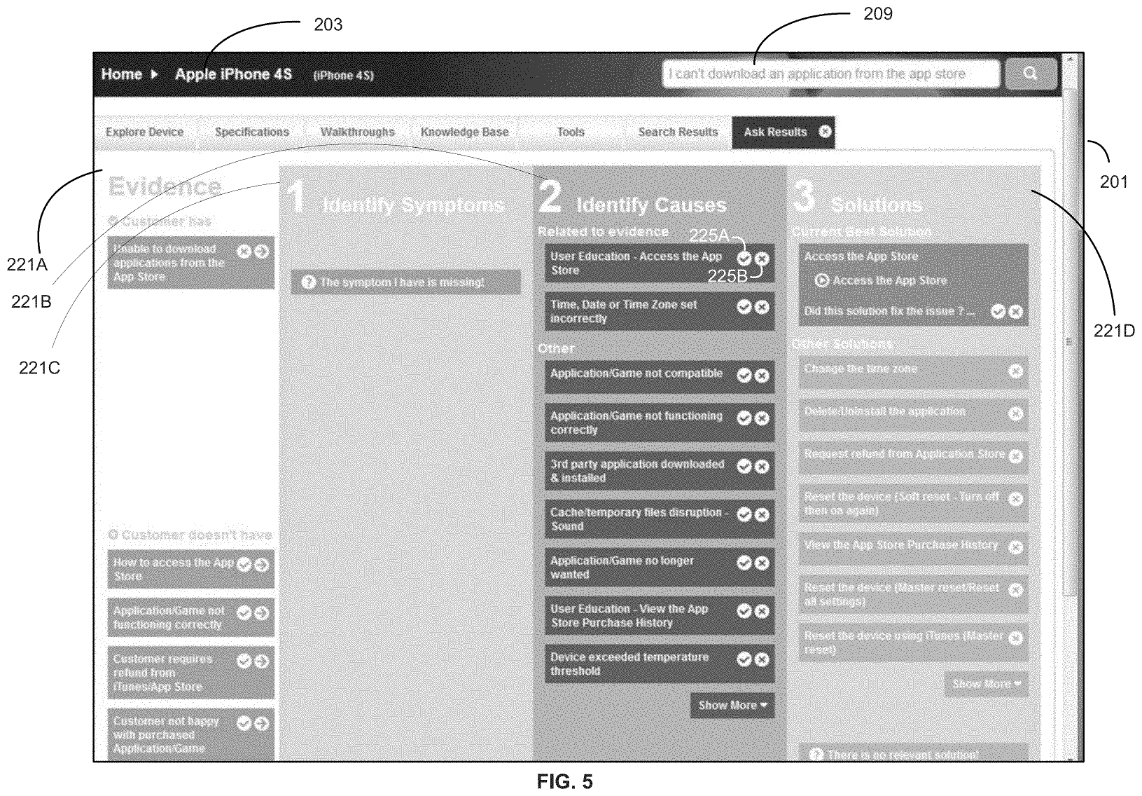

Upon classification of a given symptom, the knowledge interface 19 is configured such that the display of Region 2 is updated to remove the given symptom, and the display of Region 1 is updated to display the given symptom according to the call center representative's classification as evident from FIG. 5. In this manner, a symptom classified by the call center representative as belonging to evidentiary class A (i.e., it is “ruled-in”) moves from Region 2 to the set of evidentiary class A symptoms depicted in Region 1, and a symptom classified by the call center representative as belonging to evidentiary class B i.e., it is “ruled-out”) moves from Region 2 to the set of evidentiary class B symptoms depicted in Region 1. Note that the operations of the call center representative in classifying one or more symptoms as belonging to evidentiary class B is not strictly necessary and thus can be omitted.

When the call center representative classifies a symptom of Region 2 as belonging to evidentiary class A (or possibly to evidentiary class B), the knowledge interface 19 is configured to update the root causes depicted in Region 3 to identify those root causes that are related to the symptoms of evidentiary class A as depicted in Region 1. This is shown in FIG. 5 where the heading “Related to Evidence” identifies a set of root causes that are related to the symptoms of evidentiary class A as depicted in Region 1. When displaying in Region 3 more than one root cause that is related to the symptoms of evidentiary class A, the top-to-bottom order of such root causes as displayed in Region 3 can be based on the confidence levels of the associated symptoms such that the more-likely root causes that are related to the symptoms of evidentiary class A are depicted above the less-likely root causes that are related to the symptoms of evidentiary class A, for example under the heading “Related to Evidence.”

Each root cause depicted in Region 3 can include one or more interface widgets (such as a tick widget 225A or cross widget 225B as shown in FIG. 5) that allows the call center representative to classify the associated root cause as belonging to either evidentiary class A or evidentiary class B of Region 1. The call center representative interacts with such interface widgets to classify one or more root causes depicted in Region 3. It is also contemplated that other suitable interface schemes (such as drag and drop operations and the like) can be utilized to allow the call center representative to classify a root cause of Region 3 as belong to either evidentiary class A or evidentiary class B of Region 1. In this manner, such interaction of the call center representative can “rule-in” one or more root causes (which thus belong to the evidentiary class A of root causes) and/or can “rule-out” one or more root causes (which thus belong to the evidentiary class B of root causes).

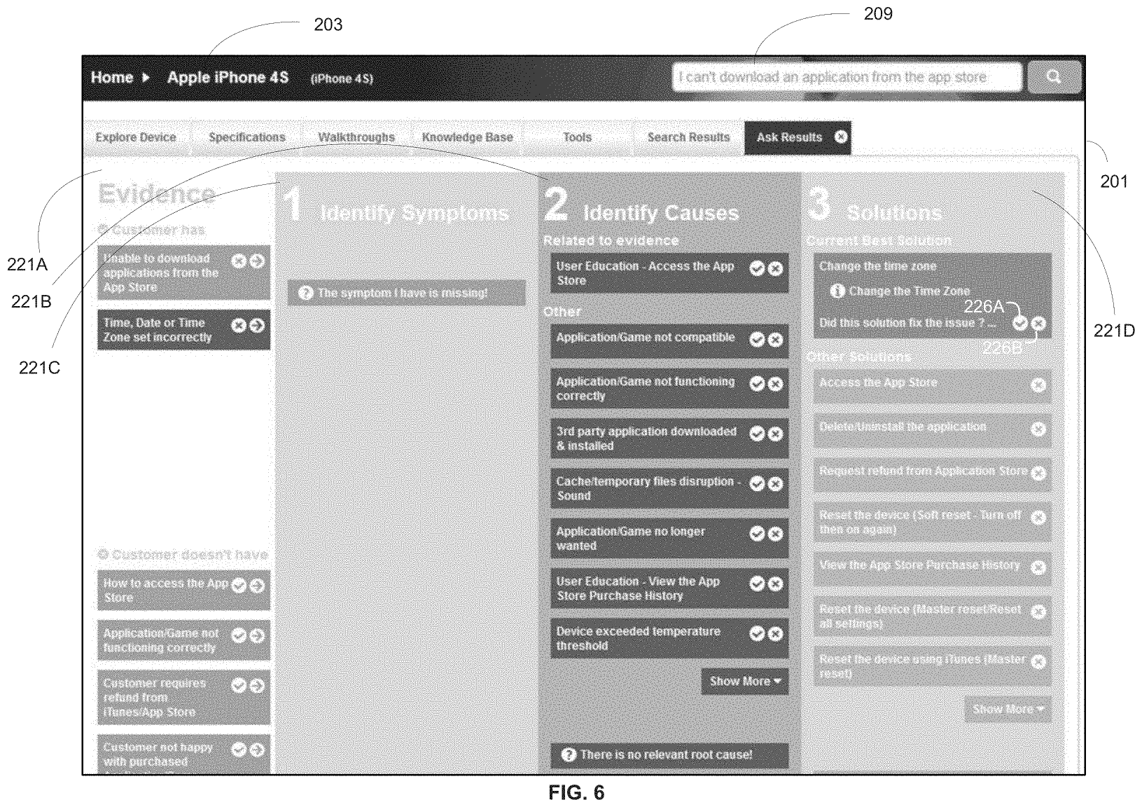

Upon classification of a given root cause, the knowledge interface 19 is configured such that the display of Region 3 is updated to remove the given root cause, and the display of Region 1 is updated to display the given root according to the call center representative's classification as evident from FIG. 6. In this manner, a root cause classified by the call center representative as belonging to evidentiary class A (i.e., it is “ruled-in”) moves from Region 3 to the set of evidentiary class A symptom(s) and root cause(s) depicted in Region 1, and a root cause classified by the user as belonging to evidentiary class B (i.e., it is “ruled-out”) moves from Region 3 to the set of evidentiary class B symptom(s) and/or root cause(s) depicted in Region 1. Note that the operations of the call center representative in classifying one or more root causes as belonging to evidentiary class B is not strictly necessary and thus can be omitted.

When the call center representative classifies a symptom or root cause as belonging to evidentiary class A (or possibly to evidentiary class B), the knowledge interface 19 is configured to update the solutions depicted in Region 4 of the display window to identify the best solution for the set of evidentiary class A symptom(s) and root cause(s) depicted in Region 1 as well as for the evidentiary class B symptom(s) and root cause(s) depicted in Region 1 (if any). This is shown in FIG. 6 where the heading “Current Best Solution” and corresponding dark shading identifies the best solution that is related to the symptom(s) and root cause(s) of evidentiary class A as well as to the evidentiary class B symptom(s) and root cause(s) depicted in Region 1 as depicted in Region 1 of the display window.

The best solution can be identified as being the solution with the highest confidence level, where the confidence level for each solution is calculated using the confidence level(s) of the root cause(s) belonging to evidentiary class A where the root cause shares a relationship with the solution. One or more acyclic directed graphs can be used to define relationships (i.e., associations) between symptoms, root causes and solutions. Such acyclic directed graph(s) can be derived from expert knowledge and updated according to the operations of the system.

It is contemplated that the call center representative user may move a symptom or route cause between the evidentiary classes A and B as depicted in Region 1, which will update the root cause and solution regions accordingly. It is also contemplated that the call center representative user may remove (declassify) a symptom or route cause from both the evidentiary classes A and B as depicted in Region 1, which will update the root cause and solution regions accordingly.

The operations of the knowledge interface 19 allows the call center representative to traverse through the symptoms that are potentially relevant to the problem or issue experienced by the customer and identify those symptoms that are relevant to the problem or issue experienced by the customer (and also possibly identify those symptoms that are not relevant to the problem or issue experienced by the customer). For some symptoms, this can involve querying the customer to gather additional information. The process also allows the call center representative to traverse through root causes that are potentially relevant to the problem or issue experienced by the customer and identify those root causes that are relevant to the problem or issue experienced by the customer (and also possibly identify those root causes that are not relevant to the problem or issue experienced by the customer). Such user-identified information is used to identify the best solution for the problem or issue experienced by the customer. This solution is presented to the call center representative in order to attempt to fix the problem or issue.

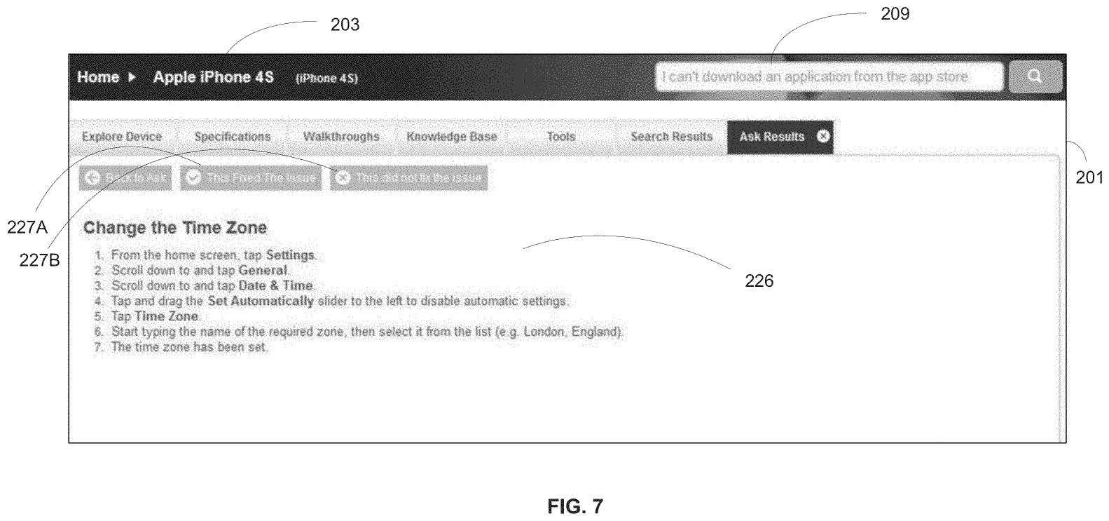

The depiction of the best solution in Region 4 can provide a user input mechanism to access additional information regarding the best solution. The additional information can be a document or other web content, an external link, an OTA flow for mobile device configuration and programming, device attributes, and/or a simulator that guides the call center representative through steps to fix a particular problem or issue. For example, it is contemplated that the call center representative can click on the depiction of the best solution in Region 4 to display a window that displays detailed instructions 226 for carrying out the best solution as well as feedback widgets 227A, 227B indicating whether or not the solution was successful as shown in FIG. 7. The best solution of Region 4 and possibly the additional information associated therewith (e.g., detailed instructions) can be used to instruct the customer how to attempt to fix the problem or issue. After the customer user follows such instructions, the call center representative can interact with the interface (for example, by clicking on one of the feedback widgets 226A and 226B of FIG. 6) in order to indicate whether or not the solution was successful.

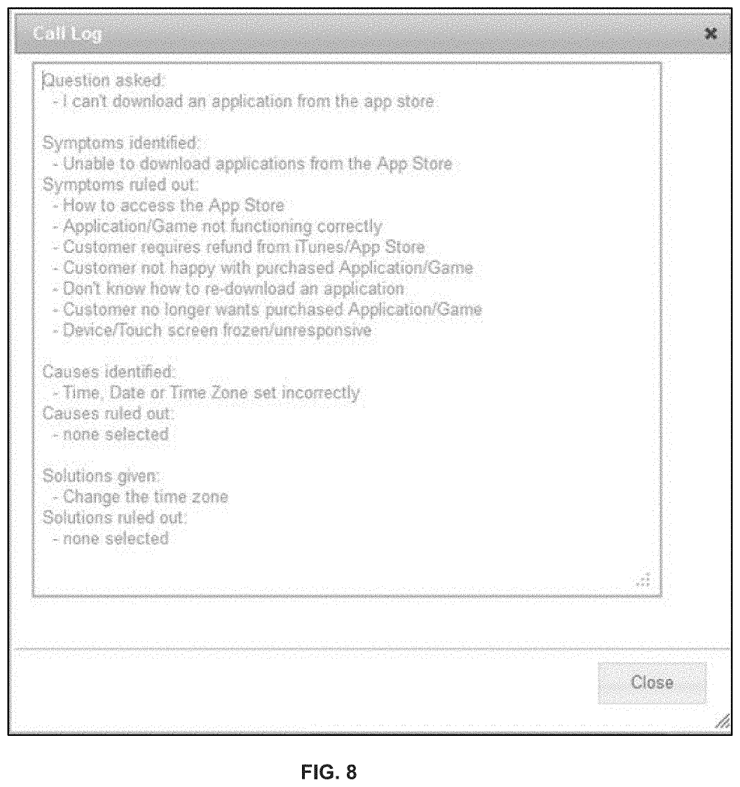

Such interaction can be used to store the user-identified evidence (the natural language textual description of the symptom(s), the user identified symptom(s), the ruled-out symptom(s), the user-identified root cause(s), the ruled-out root cause(s), the best solution and the ruled-out solution(s)) in a database as depicted in the call log of FIG. 8. Such user-identified evidence can be used to train the analysis engine 21. This allows the system to learn over time so that future iterations of the process will suggest the solution, root cause and symptoms more prominently. Such training can involve updating the weights for the acyclic directed graph(s) that provides relationships (i.e., associations) between symptoms, root causes and solutions as well as updating the statistical model used by the analysis engine to link natural textual description of symptoms to the predetermined symptoms.

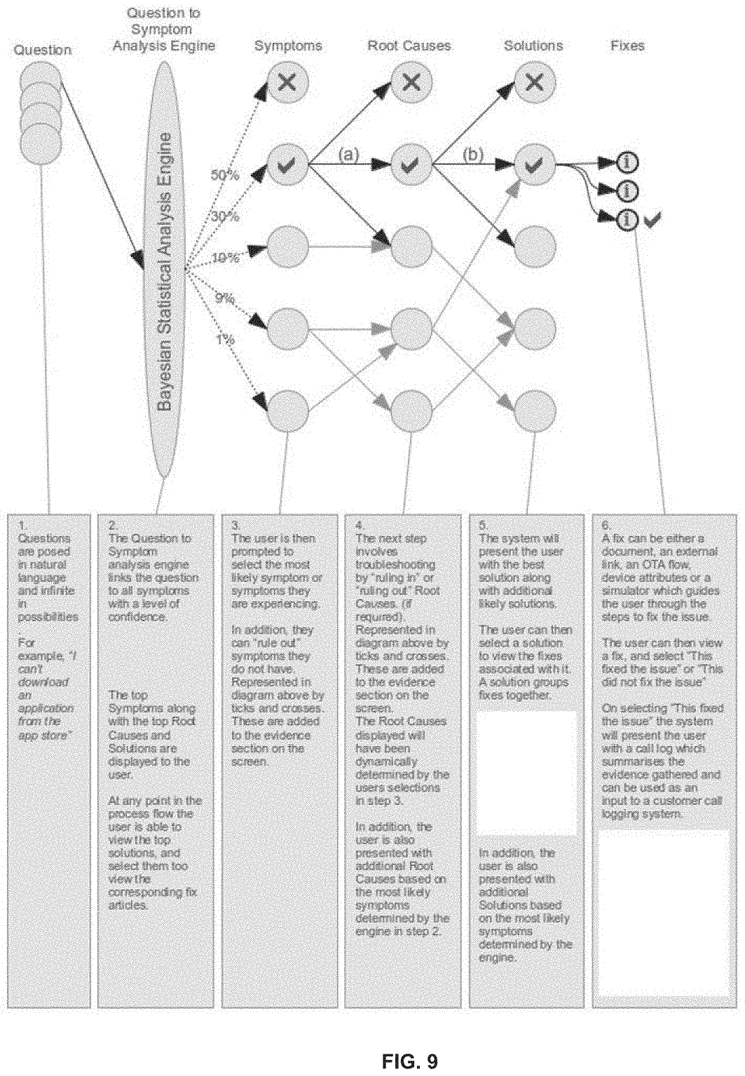

FIG. 9 shows details of exemplary processes carried out by the knowledge interface 19 and the analysis engine 21 in order to interact with a customer service representative to identify solutions to problems or issues experienced by customers in operating particular products or services as described above.

In alternate embodiments, it is contemplated that the natural language textual description of the symptom can be supplied by other mechanisms, such as in an email or instant message communication from the customer. In yet other embodiments, the processing of the knowledge interface 19 and the analysis engine 21 can be integrated into the hardware and software functionality of the customer relationship management platform 3.

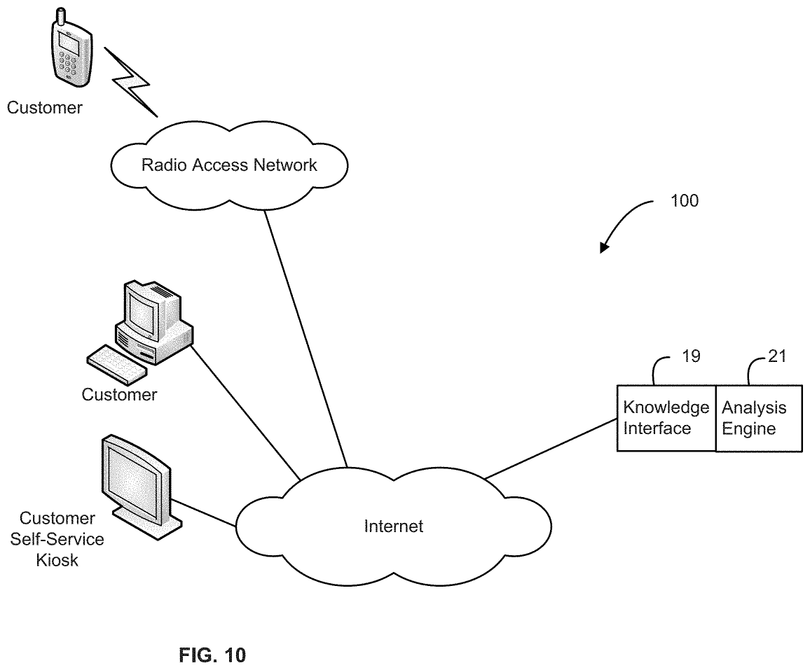

It is also contemplated that context can be derived from interaction between the customer and a self-service kiosk, a mobile application, a web site or other suitable user interface. In such applications, the processing of the knowledge interface 19 and the analysis engine 21 can allow for customers interactions via the self-service kiosk, the mobile application, the web site or the other suitable user interface as shown in the system 100 of FIG. 10. Such processing systems can be distributed in nature involving networked communication typically over the Internet as shown. Moreover, in these applications, the user of the knowledge management interface can be the customer himself/herself. In this manner, the call center representative can be omitted from the process. This allows the customer himself/herself to interact with the knowledge interface 19 to identify solutions to problems or issues experienced by customers in operating particular products or services as described above.

The system of the present application has the potential to change the paradigm of technical support call centers by making call center representatives effective much more quickly (faster ‘onboarding’), with reduced training. It can provide a higher level of first call resolution (FCR), and reduce the impact of attrition—as there is no longer a reliance on the knowledge and troubleshooting awareness in the representative's head.

Additionally, the system of the present application can allow customer interactions of a more technical nature to be handled by a level 1 resource, which is typically a lower cost than a level 2 technical environment.

Furthermore, the system of the present application can significantly improve the capability of self-care web sites, enabling a much higher call deflection rate, lowering the total cost to support complex electronic and technical products on behalf of wireless network operators, device manufacturers, service providers, and other entities that today provide support for these products.

There have been described and illustrated herein several embodiments of a system and method to identify a solution to problem or issue experienced by a customer with respect to a particular product or service. While particular embodiments of the invention have been described, it is not intended that the invention be limited thereto, as it is intended that the invention be as broad in scope as the art will allow and that the specification be read likewise. Thus, while particular display schemes and interface elements have been disclosed, it will be appreciated that other display schemes and interface elements as well. In addition, while particular types of statistical analysis methodologies have been disclosed, it will be understood that other suitable statistical analysis methodologies can be used. Moreover, while particular system configurations, architectures and corresponding methodologies have been disclosed, it will be appreciated that other system configurations, architectures and methodologies could be used as well. It will therefore be appreciated by those skilled in the art that yet other modifications could be made to the provided invention without deviating from its spirit and scope as claimed.

1.-36. (canceled)

37. A method for troubleshooting a problem or issue experienced by a customer, the method comprising:
a) generating context data in response to input from or interaction with the customer, wherein the context data identifies a particular product or service;
b) using a knowledge system to dynamically generate information based on the context data of a), wherein the knowledge system relates symptoms, causes and solutions to one another for problems or issues related to particular products or services, wherein the information generated by the knowledge system represents a number of components related to symptoms, causes and solutions for the particular product or service identified by the context data;
c) supplying the information generated in b) to a data processing system operated by a user via networked communication to present the components in a common display window;
d) displaying the components in the common display window of the data processing system and receiving user input pertaining to the components displayed in the common display window; and
e) repeating b), c), and d) based on the user input received in d) to dynamically update the components displayed in the common display window to identify a best solution to the problem or issue experienced by the customer,
wherein the components that are presented and displayed in the common display window include:
i) first data identifying a plurality of predetermined symptoms linked to the problem or issue experienced by the customer, the plurality of symptoms being presented together as a listing of symptoms,
ii) first interface elements corresponding to each of the plurality of predetermined symptoms, the first interface elements configured to allow the user in d) to selectively assign the plurality of symptoms identified by the first data to a first class of symptoms representing symptoms most likely experienced by the customer, and the first interface elements are further configured to allow the user in d) to selectively assign at least one other symptom identified by the first data to a second class of symptoms representing symptoms most likely not experienced by the customer, the first interface elements being presented together with their corresponding symptoms in the listing of symptoms,
iii) second data identifying a plurality of predetermined root causes linked to the plurality of symptoms identified by the first data, wherein the second data is updated dynamically in response to user input with respect to the first interface elements to show root causes linked to the plurality of symptoms that have been selectively assigned to the first class of symptoms as dictated by user input with the first interface elements, the plurality of root causes being presented together as a listing of root causes,
iv) second interface elements corresponding to each of the plurality of predetermined root causes, the second interface elements configured to allow the user in d) to selectively assign the plurality of root causes identified by the second data to a first class of root causes representing root causes most likely experienced by the customer, and the second interface elements are further configured to allow the user in d) to selectively assign at least one other root cause identified by the second data to a second class of root causes representing root causes most likely not experienced by the customer, the second interface elements being presented together with their corresponding root causes in the listing of root causes, and
v) third data identifying a set of solutions presented together as a listing of solutions, wherein the third data is updated dynamically in response to user input with respect to the first or second interface elements to show a best solution that is linked to the plurality of symptoms that have been selectively assigned to the first class of symptoms as dictated by user input with the first interface elements and to the plurality of root causes that have been assigned to the first class of root causes as dictated by user input with the second interface elements,
wherein the first data, the first interface elements, the second data, the second interface elements, and the third data are displayed together in a plurality of distinct regions of the common display window corresponding to respective first data, second data, and third data, wherein the distinct regions are configured to dynamically update in response to the user assigning the plurality of symptoms identified by the first data to the first class of symptoms and the user selectively assigning the plurality of root causes identified by the second data to the first class of root causes, and
wherein the plurality of distinct regions are laid out together adjacent one another across the horizontal extent of the common display window.

38. The method according to claim 37, wherein:
the knowledge system is configured to:
generate, based on the received context data generated in a) and user input in d), relationship data linking the problem or issue, the symptoms, and the causes and the solutions, wherein the relationship data is based on at least one of statistical analysis and expert knowledge, and
arrange the components in the common display window based on the relationship data.

39. The method according to claim 38, wherein:
the knowledge system is configured to display the first data and the first interface elements in a first distinct region of the common display window, to display the second data and the second interface elements in a second distinct region of the common display window, to display the third data in a third distinct region of the common display window, and to display a fourth distinct region containing classified evidence that includes the symptoms and root causes assigned to classes by the user in d).

40. The method according to claim 39, wherein:
the symptoms and root causes displayed in the fourth distinct region are dynamically relocated from the first and second distinct regions upon their assignment by the user in d).

41. The method according to claim 39, further comprising:
utilizing confidence levels associated with the symptoms identified by the first data to order the display of symptoms in the first distinct region;
utilizing confidence levels associated with the root causes identified by the second data to order the display of root causes in the second distinct region; and
utilizing confidence levels associated with the solutions identified by the third data to show the best solution in the third distinct region.

42. The method according to claim 37, further comprising:
storing in a database collected data derived from user input in d); and
using the collected data to train the knowledge system to refine the relationships between the symptoms, causes and solutions.

43. The method according to claim 37, wherein:
the plurality of symptoms, the plurality of predetermined root causes, and the set of solutions are related by one or more acyclic directed graphs.

44. The method according to claim 37, wherein:
the knowledge system generates the information in b) based on a description of a symptom of the problem or issue experienced by the customer with respect to the particular product or service.

45. The method according to claim 37, further comprising:
receiving from the user in d) a natural text description of at least one symptom of the problem or issue experienced by the customer with respect to a particular product or service,
wherein the symptoms generated in b) are linked by a statistical analysis to the natural text description.

46. The method according to claim 45, wherein:
the statistical analysis implements a naive Bayes classification methodology.

47. The method according to claim 46, wherein:
the statistical analysis associates a confidence level with the link between a given predetermined symptom and the natural language textual description of the problem or issue experienced by the customer with respect to a particular product or service.

48. The method according to claim 37, wherein:
the context data is received from interaction between a call center representative and the customer.

49. The method according to claim 37, wherein:
the context data is supplied by input from the customer.

50. The method according to claim 37, further comprising:
in response to receiving user input in d) pertaining to solutions, triggering a display of additional information regarding a best solution to the user.

51. The method according to claim 50, wherein:
the additional information is selected from the group including
i) a document or other web content,
ii) an external link,
iii) an OTA flow for mobile device configuration and programming,
iv) device attributes, and
v) a simulation that guides the call center representative through steps to fix a particular problem or issue.

52. The method according to claim 37, wherein:
the user of the data processing system is a call center representative.

53. The method according to claim 37, wherein:
the user of the data processing system is the customer.

54. A troubleshooting system for troubleshooting a problem or issue experienced by a customer, the system comprising:
a customer relationship management platform configured to generate context data in response to input from or interaction with the customer, wherein the context data identifies a particular product or service;
a knowledge system configured to dynamically generate information based on the context data, wherein the knowledge system relates symptoms, causes and solutions to one another for problems or issues related to particular products or services, wherein the information generated by the knowledge system represents a number of components related to symptoms, causes and solutions for the particular product or service identified by the context data; and
a data processing system operable by a user, the data processing system configured to:
receive information supplied by the knowledge system via networked communication to present the components in a common display window;
display the components in the common display window of the data processing system; and
receive user input pertaining to the components displayed in the common display window,
wherein the troubleshooting system is configured to repeatedly use the knowledge system to dynamically generate information based on the context data, supply the information generated from the knowledge system to the data processing system operated by the user, and receive the user input pertaining to the components displayed in the common display window, to dynamically update the components presented and displayed in the common display window to identify a best solution to the problem or issue experienced by the customer,
wherein the components that are presented and displayed in the common display window include:
i) first data identifying a plurality of predetermined symptoms linked to the problem or issue experienced by the customer, the plurality of symptoms being presented together as a listing of symptoms,
ii) first interface elements corresponding to each of the plurality of predetermined symptoms, the first interface elements configured to allow the user to selectively assign the plurality of symptoms identified by the first data to a first class of symptoms representing symptoms most likely experienced by the customer, and the first interface elements are further configured to allow the user to selectively assign at least one other symptom identified by the first data to a second class of symptoms representing symptoms most likely not experienced by the customer, the first interface elements being presented together with their corresponding symptoms in the listing of symptoms,
iii) second data identifying a plurality of predetermined root causes linked to the plurality of symptoms identified by the first data, wherein the second data is updated dynamically in response to user input with respect to the first interface elements to show root causes linked to the plurality of symptoms that have been selectively assigned to the first class of symptoms as dictated by user input with the first interface elements, the plurality of root causes being presented together as a listing of root causes,
iv) second interface elements corresponding to each of the plurality of predetermined root causes, the second interface elements configured to allow the user selectively assign the plurality of root causes identified by the second data to a first class of root causes representing root causes most likely experienced by the customer, and the second interface elements are further configured to allow the user to selectively assign at least one other root cause identified by the second data to a second class of root causes representing root causes most likely not experienced by the customer, the second interface elements being presented together with their corresponding root causes in the listing of root causes, and
v) third data identifying a set of solutions presented together as a listing of solutions, wherein the third data is updated dynamically in response to user input with respect to the first or second interface elements to show a best solution that is linked to the plurality of symptoms that have been selectively assigned to the first class of symptoms as dictated by user input with the first interface elements and to the plurality of root causes that have been assigned to the first class of root causes as dictated by user input with the second interface elements,
wherein the first data, the first interface elements, the second data, the second interface elements, and the third data are displayed together in a plurality of distinct regions of the common display window corresponding to respective first data, second data, and third data, wherein the distinct regions are configured to dynamically update in response to the user assigning the plurality of symptoms identified by the first data to the first class of symptoms and the user selectively assigning the plurality of root causes identified by the second data to the first class of root causes, and
wherein the plurality of distinct regions are laid out together adjacent one another across the horizontal extent of the common display window.

55. The system according to claim 54, wherein the knowledge system is configured to:
generate, based on the received context data generated by the customer relationship management platform and the user input, relationship data linking the problem or issue, the symptoms, and the causes and the solutions, wherein the relationship data is based on at least one of statistical analysis and expert knowledge; and
arrange the components in the common display window based on the relationship data.

56. The system according to claim 55, wherein:
the knowledge system is configured to display the first data and the first interface elements in a first distinct region of the common display window, to display the second data and the second interface elements in a second distinct region of the common display window, to display the third data in a third distinct region of the common display window, and to display a fourth distinct region containing classified evidence that includes the symptoms and root causes assigned to classes by the user.

57. The system according to claim 56, wherein:
the symptoms and root causes displayed in the fourth distinct region are dynamically relocated from the first and second distinct regions upon their assignment by the user.

58. The system according to claim 56, wherein:
confidence levels associated with the symptoms identified by the first data are utilized to order the display of symptoms in the first distinct region;
confidence levels associated with the root causes identified by the second data are utilized to order the display of root causes in the second distinct region; and
confidence levels associated with the solutions identified by the third data are utilized to show the best solution in the third distinct region.

59. The system according to claim 54, wherein the system is further configured to:
store collected data derived from user input in a database; and
use the collected data to train the knowledge system to refine the relationships between the symptoms, causes and solutions.

60. The system according to claim 54, wherein:
the plurality of symptoms, the plurality of predetermined root causes, and the set of solutions are related by one or more acyclic directed graphs.

61. The system according to claim 54, wherein:
the knowledge system generates the information based on a description of a symptom of the problem or issue experienced by the customer with respect to the particular product or service.

62. The system according to claim 54, wherein the data processing system operable by the user is configured to:
receive from the user a natural text description of at least one symptom of the problem or issue experienced by the customer with respect to a particular product or service,
wherein the symptoms generated are linked by a statistical analysis to the natural text description.

63. The system according to claim 62, wherein:
the statistical analysis implements a naive Bayes classification methodology.

64. The system according to claim 63, wherein:
the statistical analysis associates a confidence level with the link between a given predetermined symptom and the natural language textual description of the problem or issue experienced by the customer with respect to a particular product or service.

65. The system according to claim 54, wherein:
the context data is received from interaction between a call center representative and the customer.

66. The system according to claim 54, wherein:
the context data is supplied by input from the customer.

67. The system according to claim 54, wherein the troubleshooting system is configured to, in response to receiving user input pertaining to solutions, trigger a display of additional information regarding a best solution to the user.

68. The system according to claim 67, wherein:
the additional information is selected from the group including
i) a document or other web content,
ii) an external link,
iii) an OTA flow for mobile device configuration and programming,
iv) device attributes, and
v) a simulation that guides the call center representative through steps to fix a particular problem or issue.

69. The system according to claim 54, wherein:
the user of the data processing system is a call center representative.

70. The system according to claim 54, wherein:
the user of the data processing system is the customer.
